(19) United States
(12) Patent Application Publication
(10) Pub. No.: US 2018/0272505 A1
(43) Pub. Date: Sep. 27, 2018

(54) Hub for Ratchet Gears

(71) Applicant: Snap-on Incorporated, Kenosha, WI (US)

(72) Inventor: Dave Ross, Beach Park, IL (US)

(73) Assignee: Snap-on Incorporated, Kenosha, WI (US)

(21) Appl. No.: 15/465,672

(22) Filed: Mar. 22, 2017

(51) Int. Cl. B25B 13/46

(52) U.S. Cl. CPC B25B 13/463

(57) ABSTRACT

A ratchet gear system with a drive gear. The drive gear can be disposed around a hub extending from within the cavity of the head to avoid the need to machine an indent into the head itself. The drive gear can mate with the hub via a drive gear indent. The drive gear and hub can then accept the load created when a user applies torque with the tool.

### TECHNICAL FIELD OF THE INVENTION

The present invention relates generally to ratchet tools. More particularly, the present invention relates to a hub formed in the head of a ratchet tool to increase stability of drive gears in ratchet tools.

### BACKGROUND OF THE INVENTION

Ratchet tools are found in many different forms. These tools include ratchet wrenches, screwdrivers, or other tools that selectively rotate to apply torque to a work piece. The tool rotates in a first rotational direction to apply torque, and then rotates or ratchets in a second ratcheting rotational direction without applying torque. Afterwards, the tool can be rotated in the first rotational direction again to apply additional torque to the work piece to continue to drive the work piece into a desired position and tightness. Typically, the torque applying and ratcheting rotational directions of the ratchet tool are selectable by a user. Therefore, a user can selectively apply torque in either of clockwise or counterclockwise directions, while respectively ratcheting in the counterclockwise or clockwise directions.

Ratchet tools may include an accessory, for example a bit or socket, that engages and applies the torque to a work piece. A drive gear is typically disposed within the tool and cooperatively engages a pawl to effect the selective rotational direction of the drive, wherein the drive gear transfers torque to the accessory, which then transfers the torque to the work piece. Typically, a high load or force is applied to the drive gear and the pawl, and between the drive gear and the drive, during use, which can cause binding or premature failure of the tool. For example, this loading or force can be applied through the drive gear teeth to the drive, or via a hub that is part of the drive gear.

### SUMMARY OF THE INVENTION

An embodiment of the present invention broadly comprises a ratchet gear system including a drive gear that matingly engages an internal hub protruding disposed within the inside of the head. The drive gear can include an indent correspondingly shaped to the hub to cooperatively engage the hub and better absorb or dissipate loads or forces applied to the gear during use of the tool. The hub can fit within the indent of the drive gear to provide a structurally stable mating engagement, and transfer or accept the loadings or forces applied to the tool during use caused when a user applies torque from the tool to a work piece.

In an embodiment, the present invention broadly comprises a tool including a gear, a drive coupled to the gear that is adapted to receive torque from the gear, and a head that houses the gear. The head includes a hub extending towards the gear housed within the head. The gear includes an indent that receives substantially the entire hub.

In another embodiment, the present invention broadly comprises a tool head assembly including a housing, a gear disposed within the housing, and a drive coupled to the gear and that receives torque from the gear. The tool head assembly can include a hub disposed within the housing, and that fits entirely within an indent of the gear.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a tool according to at least some of the presently disclosed embodiments;

FIG. 2 is an enlarged, sectional side view of a head of a tool, taken along the longitudinal axis of the tool, according to at least some of the presently disclosed embodiments;

FIG. 3 is a front exploded, perspective view of a tool according to at least some of the presently disclosed embodiments; and

FIG. 4 is a rear exploded side view of a tool according to at least some of the presently disclosed embodiments.

### DETAILED DESCRIPTION OF THE EMBODIMENTS

While the present invention is susceptible of embodiments in many different forms, there is shown in the drawings, and will herein be described in detail, embodiments, including a preferred embodiment, of the invention with the understanding that the present disclosure is to be considered as an exemplification of the principles of the invention and is not intended to limit the broad aspect of the invention to any one or more of the embodiments illustrated or disclosed. As used herein, the term “present invention” is not intended to limit the scope of the claimed invention, and is instead a term used to discuss exemplary embodiments of the invention for explanatory purposes only.

The present invention broadly comprises a ratchet gear system that includes a drive gear cooperatively disposed around a hub extending from inside a cavity of a head of the tool. The drive gear can include an indent that matingly and cooperatively engages the hub to provide a structurally stable configuration that accepts loads or forces created when a user applies torque to a work piece during use of the tool. Moreover, it will be appreciated that the hub and intent cooperation discussed herein aligns the ratchet gear assembly within the head of the tool.

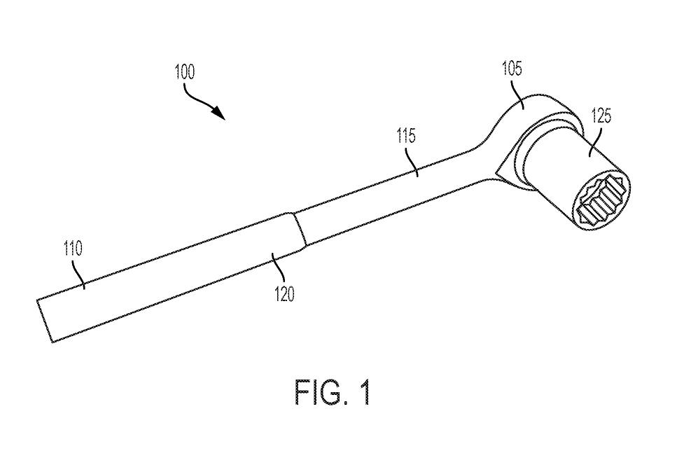

Referring to FIG. 1, the tool 100 can include a head 105 and a handle 110 with an extension 115 extending therebetween. The head 105 can include a housing or cavity for internal components of the tool 100, including the ratchet gear system. The handle 110 can include a grip portion 120 to assist the user in holding the tool 100, and the ratchet gear system is adapted to be coupled with an accessory 125, for example a bit or socket, that is then adapted to engage a work piece to apply torque to the work piece.

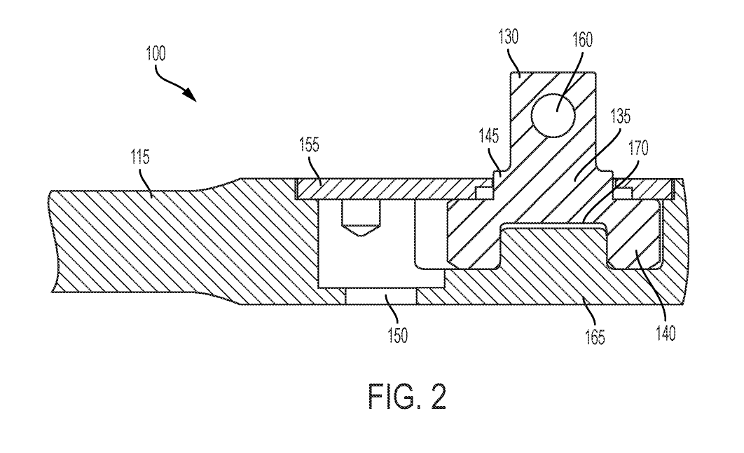

As shown in FIG. 2, the tool 100 can include an outwardly protruding lug 130 that matingly couples with the accessory 125, and, with the accessory 125 installed on the lug 130, transfers torque to the work piece. The lug 130 shaped is well-known, and can be a rectangular prism that couples to or is integral with a gear 135 (also known as a “drive gear”). The gear 135 can include circumferentially disposed gear teeth, an outer portion 140 and a base 145, and the head 105 can further include an opening 150, wherein a reversing lever (discussed below) can be inserted into for selecting the rotational drive direction of the tool. A cover plate 155 can enclose the cavity, and a ball detent 160 can be provided in the lug 130 to detainably couple or engaged the accessory 125, thus temporarily detaining the accessory to the lug 130, in a well-known manner. For example, the ball detent 160 can be spring biased outwardly, and can therefore be pressed inwardly against the bias when the accessory 125 is inserted onto the lug 130, and again biased outwardly and engage an indent disposed the accessory 125 when the accessory 125 is inserted over the lug 130, in a well-known manner.

The outer portion 140 of the gear 135 can extend around and cooperatively engage a hub 165 disposed within the cavity of the head 105 to improve structural stability. For example, referring to FIGS. 2-4, the gear 135 can include an indent 170 that matingly receives the hub 165 when the tool 100 is in an assembled condition, wherein the hub 165 and indent 170 cooperatively control the gear 135. For example, the hub 165 and indent 170 can both be cooperatively shaped, such as circular, and the gear 135 can rotate around the hub 165, and further rotate relative to the head 105. The hub 165 can be integrally formed within the cavity of the head 105.

The hub 165 of the present invention provides less head thickness compared to other hub designs because it does not require an indent to be machined into the head itself or a hub formed on the gear. Rather, the indent for the hub 165 is located within the gear 135, and the corresponding hub 165 within the cavity of the head 105, avoiding the necessity for machining or forming an indent within the head 105. Existing hub designs extend the hub from the gear into indents disposed within the head, which requires the special machining described above, in addition to a thicker head to accommodate the hub. In some embodiments, the hub 165 of the present invention can extend substantially entirely within the indent 170 of the gear 135 to more fully receive loads and forces during application of torque to a work piece from the tool 100. For example, other than normal tolerances for machining and assembly, the hub 165 can extend substantially entirely within the indent 170 to better receive loads and forces applied and to provide better structural stability of the ratchet gear system. One of ordinary skill will appreciate that the greater the depth of the indent 170 and hub 165, the greater the absorption of the load or forces created during use of the tool 100.

The base 145 can act as an additional aligning hub of the gear 135 on an opposite side of the hub 165. Although optional in some embodiments, the base 145 can cooperatively engage a correspondingly sized aperture disposed in the cover plate 155 and provide further structural stability and alignment of the gear 135 at a surface opposite to that of the hub 165. For example, the base 145 can receive portions of the loads or forces created when a user uses the tool 100, and distribute those loads or forces throughout the cover plate 155 and to the tool 100 as a whole. In some embodiments, the hub 165 provides sufficient structural stability to receive the loads and forces created when torque is applied to the work piece, and the base 145 need not be included in the tool 100. Instead, the base 145 can be omitted and the cover plate 155 can extend more closely around the drive 130.

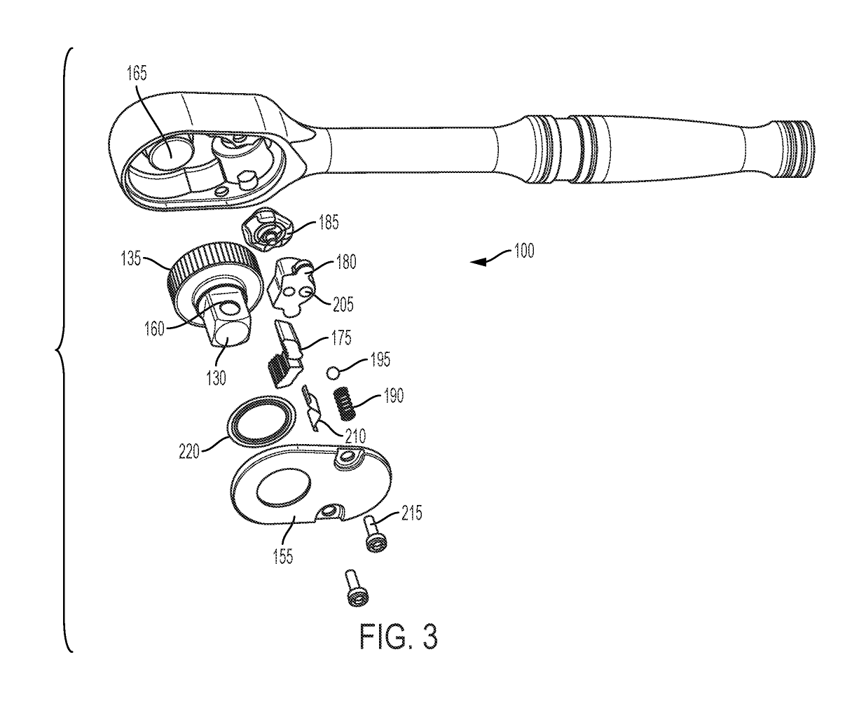

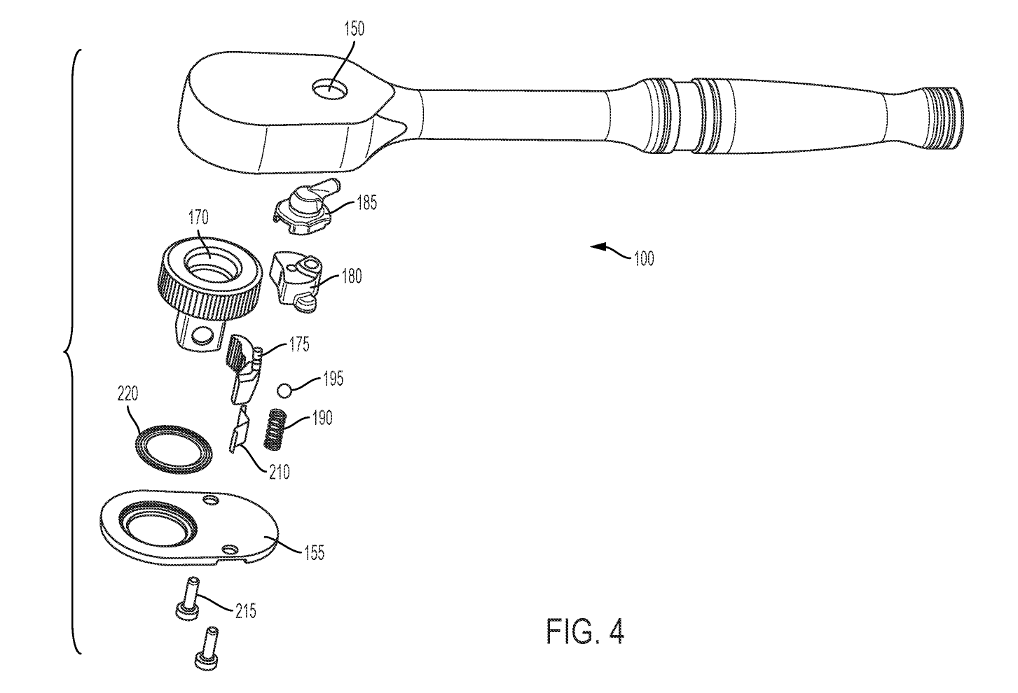

Referring also to FIGS. 3 and 4, the tool 100 can include a pawl 175 that selectively matingly engages the gear teeth of the gear 135 to prevent or allow rotational movement of the gear 135 in a selected rotational direction. For example, a two pawl 175 design, as shown in FIG. 3, allows a first pawl to matingly engage the gear 135 and allow rotational movement of the gear 135 to apply torque in a first rotational direction, but slip or ratchet with respect to the tool 100 when the tool 100 is rotated in the second rotational direction opposite the first rotational direction. The second pawl would operate in the opposite manner, and matingly engage the gear 135 when the gear 135 rotates in the second rotational direction to apply torque, but slip or ratchet with respect to the gear 135 when the tool 100 rotates in the first rotational direction opposite the second rotational direction.

The pawl(s) 175 can be coupled to a carrier 180 that is movable via a reversing lever 185 to allow selective engagement of the pawl(s) 175 with gear 135. For example, a user can rotate the reversing lever 185 to select a first or second rotational direction of the tool 100, and more specifically, the lug 130 and the gear 135. As discussed previously, the reversing lever 185 can be located partially inside the cavity of the head 105 under the cover plate 155, and can extend outside of the tool 100 through the opening 150 in the head 105. By rotating the reversing lever 185 in a first rotational direction, a user can select a first torque application direction (e.g., clockwise, and ratcheting in a counterclockwise direction) of the lug 130 and/or gear 135, and by rotating the reversing lever 185 in a second rotational direction opposite the first rotational direction, the user can select a second torque application direction (e.g., counterclockwise and ratcheting in a clockwise direction) of the lug 130 and/or gear 135.

The tool 100 can further include a spring 190 and ball 195 that fits within a detent 205 of the carrier 180. The spring 190 and ball 195 can provide a spring-loaded, tactile indication when the user rotates the reversing lever 185 to a desired position that then selects either of the first or second torque application directions of the tool 100. For example, the spring 190 can bias the ball 195 outwardly towards the internal wall of the head 105, such that the ball 195 is in constant contact with the wall. The ball 195 can then cooperatively engage a detent disposed within the head 105 to “click” into place and provide a tactile and/or audible indication to the user that the desired torque application direction has been selected by the user via the reversing lever 185.

In an embodiment, a leaf spring 210 can be provided inside the head 105 of the tool 100 to bias a selected one of the pawl(s) 175 into engagement with the gear teeth of the gear 135. The leaf spring 210 can therefore bias the selected pawl 175 into selective engagement with the gear 135 during use of the tool 100. As shown, the leaf spring 210 can rest against the a side of the carrier 180 that faces the gear 135, and the carrier 180 can engage the leaf spring 210 to bias the selected pawl 175 into engagement with the gear 135. In this manner, the selected pawl 175 can better matingly engage the gear 135 and reduce unwanted slipping or disengagement of the pawl 175 with respect to the gear 135.

Various other elements can facilitate the smooth movement of the tool 100 and maintain the components of the tool 100 in their desired orientation. For example, as shown, fasteners 215 can couple the cover plate 155 to the head 105 in a well-known manner. Further, a ring 220 can act as the interface between an axial face of the gear 135 and the internal-facing surface of the cover plate 155, for example, to reduce friction between the two surfaces during use of the tool 100, and to better seal the internal cavity of the head 105.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A tool including a head with a cavity that houses a gear having a lug coupled thereto, comprising:
a hub disposed in the cavity, and
an indent disposed on the gear, wherein the indent is adapted to cooperatively receive the hub when the gear is disposed in the cavity, and the gear is adapted rotate relative to the hub.

2. The tool of claim 1, wherein the gear includes an outer portion that surrounds the hub.

3. The tool of claim 1, further comprising a cover plate that at least partially encloses the cavity.

4. The tool of claim 3, wherein the gear includes a base disposed opposite the hub that is cooperatively received in an aperture disposed in the cover plate.

5. The tool of claim 1, wherein the hub and indent each have a circular cross-sectional shaped.

6. The tool of claim 1, further comprising a pawl adapted to be disposed in the cavity that is adapted to selectively engage the gear to selectively allow and prevent rotation of the gear relative to the head.

7. The tool of claim 6, further comprising a selecting lever that allows a user to selectively engage and disengage the pawl with the gear.

8. The tool of claim 6, further comprising a carrier coupled to the pawl that rotates to engage the pawl into the gear.

9. The tool of claim 8, further comprising a spring and ball detent mechanism, and a bore disposed on the carrier, wherein the spring and ball detent mechanism is disposed within the bore and is adapted to provide a tactile indication to a user when the user selects a rotational direction of the drive.

10. The tool of claim 8, further comprising a leaf spring abutting the carrier to apply a bias force to the pawl to bias the pawl into engagement with the gear.

11. A tool assembly, comprising:
a cavity;
a gear disposed within the cavity;
a drive coupled to the gear; and
a hub disposed within the housing,
wherein the gear includes an indent that cooperatively engages the hub.

12. The tool head assembly of claim 11, wherein the gear includes an outer portion that surrounds the hub.

13. The tool head assembly of claim 11, wherein the gear includes a base disposed opposite the hub and that extends outwardly relative to the housing.

14. The tool head assembly of claim 11, wherein the hub and indent are cooperatively circular shaped and the gear rotates around the hub.

15. The tool head assembly of claim 11, wherein the hub and indent are cooperatively circular shaped and the gear rotates around the hub.

16. The tool head assembly of claim 11, further comprising a pawl that engages the gear to selectively allow and prevent rotation of the gear.

17. The tool head assembly of claim 16, further comprising a selecting lever that allows a user to select a rotational direction of the drive.

18. The tool head assembly of claim 16, further comprising:
a carrier coupled to the pawl that rotates to selectively engage the pawl with the gear, the carrier including a bore; and
a spring and ball mechanism disposed within the bore that is adapted to provide a tactile indication to a user when the user selects a rotational direction of the drive.

19. The tool head assembly of claim 18, further comprising a leaf spring abutting the carrier and applying a bias force to the pawl to engage the pawl with the gear.
